(19) United States
(12) Patent Application Publication
(10) Pub. No.: US 2024/0328849 A1
(43) Pub. Date: Oct. 3, 2024

(54) VIBRATION SENSOR

(71) Applicant: VEGA Grieshaber KG, Wolfach (DE)

(72) Inventors: Holger Gruhler, Tuningen (DE); Julian Epting, Hornberg (DE); Benjamin Schätzle, Schuttertal (DE)

(21) Appl. No.: 18/616,262

(22) Filed: Mar. 26, 2024

(30) Foreign Application Priority Data
Mar. 27, 2023 (DE) 10 2023 107 707.4

(51) Int. Cl. G01H 11/08

(52) U.S. Cl. CPC G01H 11/08

(57) ABSTRACT

A vibration sensor for detecting fill levels, limit levels, or for monitoring process parameters, having a membrane that can be set in vibration, a piezo actuator which has a piezo element and an electrode with a surface connected to said piezo element, an adhesive connection operatively connected to the membrane in such a way that vibrations of the piezo actuator can be transmitted to the membrane, and an electronic system electrically connected to the electrode surface, in which the piezo element has a recess and the electrical connection extends through this recess.

The invention relates to a vibration sensor as claimed in patent claim 1.

Vibration sensors such as those used as vibration limit switches are generally known from prior art and such a vibration sensor typically includes a membrane which may be excited to oscillate by means of a drive unit and which, in many cases, is used to excite a mechanical oscillator arranged on the membrane, such as an oscillating fork, causing the latter to oscillate. Depending on the level up to which it is covered by a filling medium, and on the degree of viscosity of such filling medium, this mechanical oscillator can oscillate at a characteristic frequency, which can then be detected by the vibration sensor and converted into a measurement signal. Vibration sensors of this type can also be referred to as vibronic sensors. The electromechanical transducers employed in the drive unit of such a sensor are often piezo actuators having a piezo element, e.g. a piezoceramic element. A well-known approach consists in fixing the piezo actuator by means of an adhesive connection. This approach is being used more and more frequently, as it offers improved performance, lower manufacturing costs and greater automation capability than would be possible, for example, with a screw-mounted piezo actuator.

For this purpose, an adhesive layer may be applied onto the membrane, a compensating element, e.g. a compensating ceramic element, may be bonded to said membrane, another adhesive layer may then be applied onto the compensating ceramic element, thus establishing an adhesive connection, joining the latter to the piezo actuator. The piezo actuator can then be electrically contacted, e.g. via a flexible printed circuit board. The flexible printed circuit board can be of the type known as flex conductors.

The disadvantage here can be that the piezo actuator must be very precisely aligned with respect to its position and rotational orientation prior to the bonding procedure and must often be held in a fixed position until the adhesive has cured. In addition, this alignment is often difficult to achieve. Another disadvantage may be that the performance of the piezo actuator is not as high as would be desirable.

The object of the invention therefore consists in providing an improved vibration sensor.

This object is achieved, according to the invention, with the features of claim 1. Further practical embodiments and advantages are described in connection with the dependent claims.

A vibration sensor according to the invention is used for detecting fill levels, limit levels, or for monitoring process parameters, and comprises a membrane that can be set in vibration. In addition, a vibration sensor according to the invention comprises a drive unit, said drive unit comprising a piezo actuator. The piezo actuator has a piezo element and an electrode connected to the piezo element. The electrode has an electrode surface. In addition, a vibration sensor according to the invention comprises an adhesive connection by means of which the piezo actuator is operatively connected to the membrane in such a way that vibrations of the piezo actuator can be transmitted to the membrane and, preferably, vibrations of the membrane can also be transmitted to the piezo actuator. Preferably, the piezo actuator is used both to set the membrane in vibration and to detect the vibration of the membrane. The drive unit is in particular a bonded piezo drive or a bonded piezo actuator. In addition, a vibration sensor according to the invention comprises an electronic system and an electrical connection between the electronic system and the electrode surface. The piezo element has a recess and the electrical connection extends through this recess.

In this way, provision is made for the electrical connection to affect the active surface of the piezo element in a way that will cause no, or only minor, interference modes. In particular, this structural design causes the drive unit to be less susceptible to interference modes and/or ensures that the latter, should they occur, will not lead to the emission of such a large erroneous signal. Due to this structural approach, the piezo drive can be designed in a particularly simple and symmetrical, e.g. rotationally symmetrical, manner. In the context of this publication, the term ‘rotationally symmetrical’ is to be understood as meaning that a rotation to any desired angle around the axis of rotation results in an exact image of itself. In addition, the precise mounting of the piezo actuator in the sensor can thus be simplified. Interference modes favoured by asymmetries in the structure of the piezo actuator or by non-precise, e.g. asymmetrical or decentralised or twisted mounting of the piezo actuator in the sensor—for example due to position tolerances of the bonded piezo actuator—may thus be reduced. Furthermore, even the detection and excitation of interfering vibrations caused by external oscillations may be attenuated by the electronic system when operating in the receiving mode of the piezo actuator. It has been shown that if a prior art piezo actuator is precisely positioned in a prior art vibration sensor, for example if the piezo actuator is bonded perfectly centrally, external vibrations have only minor effects on its function and critical interference signals, which would arise with decentralised bonding, for example, can be largely avoided. This can be achieved more easily when using a vibration sensor according to the invention. A vibration sensor according to the invention can be less sensitive to position tolerances of the piezo actuator. It is thus possible to reduce or prevent the effect that, due to the geometry of the piezo actuator and the matching oscillating fork structure, an asymmetrical or offset positioning of the piezo actuator favours or amplifies erroneous signals in the event of external excitation by interference modes.

In addition, provision is made for the electrical connection to affect the active surface of the piezo element only to a very small extent. This can improve the performance of the piezo actuator. The effort required to align the piezo actuator with regard to its position and/or rotational orientation, for example relative to an oscillating fork of the vibration sensor, may thus be reduced.

The vibration sensor will hereinafter also be shortly referred to as ‘sensor’. The term ‘piezo element’ is used in this publication to refer to the part of the piezo actuator formed by the piezoelectric material, e.g. a piezo disc. The piezo element may be, for example, a piezo crystal or a piezoelectric ceramic element.

Preferably, the piezo element has a first side facing towards the membrane. In the context of this publication, the term “electrode surface” refers in particular to the part of the electrode that is arranged—preferably exclusively—on this first side of the piezo element. The electrode surface is preferably in the shape of a circular ring. Preferably, the piezo element has a second side facing away from the membrane. Preferably, the recess extends through the piezo element, in particular from the first side to the second side. The recess can have the shape of a hole and the wall of the recess can be hollow cylindrical.

The electrode surface is preferably arranged in the sensor between the piezo element and another component, such as a compensating element or the membrane, and is therefore not freely accessible. The electrode surface is preferably covered by the adhesive connection, with said connection covering in particular its entire surface area.

The adhesive connection by means of which the piezo actuator is operatively connected to the membrane in such a way that vibrations of the piezo actuator can be transmitted to the membrane may also be referred to as an adhesive mounting connection. The piezo actuator can be mounted within the sensor by means of this adhesive mounting connection.

The electrode, in particular the electrode surface, can be contacted by means of the electrical connection. Preferably, the electrode surface can be contacted from the side of the piezo element facing away from the membrane, i.e. usually from above, said contacting passing through the recess. Contacting occurs in particular around the piezo element or around an edge of the piezo element formed in particular by the recess and may therefore also be referred to as a recontacting.

One region of the piezo actuator is preferably used to set the membrane in vibration. Preferably, the piezo actuator does not have separate regions specifically designed for exciting and detecting the vibration of the membrane. In the preferred embodiment variant, a common region of the piezo actuator is used both for setting the membrane in vibration and for determining the frequency and/or amplitude with which the membrane vibrates. Preferably, a common region of the piezo actuator is used—e.g. alternately—as a transmitter and a receiver. Preferably, the electrode is galvanically isolated from the membrane.

The electronic system consists in particular of electronic components by means of which the piezo actuator is supplied with drive energy and/or by means of which the signals detected by the piezo actuator are evaluated. The electronic system can be an electronic evaluation unit. To ensure power supply, the electronic system is connected in particular to a power source. The electronic system can be arranged within a housing which serves for insulating and shielding the electronic system.

In the context of this publication, the term “electrical connection between the electronic system and the electrode surface” refers in particular to the entirety of all elements electrically connecting the electrode surface to the electronic system. The electrical connection preferably extends partly inside and partly outside the recess. The electrical connection can comprise an electrical line, e.g. a cable and/or a flexible printed circuit board. The electrical connection can comprise a contact element for making electrical contact with the electrode or electrode surface, in particular for connecting the electrical line or a printed circuit board to the electrode or electrode surface, e.g. a solder lug or a plug-in contact. The plug-in contact can be crimpable. The electrical connection can comprise a soldered, bonded and/or welded connection, in particular between the electrical line and/or a printed circuit board, on the one hand, and the electrode or electrode surface and/or the contact element, on the other. The printed circuit board can be made of rigid material or of flexible material. The printed circuit board can also be referred to as circuit board.

The piezo element preferably extends in one plane. Preferably, the piezo element has a base surface located in particular in this plane. If the electrical connection, when considered in the plane of the piezo element, does not protrude beyond the contour of the piezo element, the sensor can have a particularly compact design. If the piezo element has the shape of a circular disc with a circular ring on top and a circular ring on the bottom, then the term ‘base surface’ is to be understood as referring to the surface of one of these circular rings.

If the adhesive connection is electrically conductive and preferably forms the electrode surface, this can result in a particularly simple structure.

Preferably, the adhesive connection is not electrically conductive. In this way, it can have a very small thickness and transmit vibrations with particularly low losses.

If the recess extends through the centre of the piezo element, provision will further be made for the electrical connection or the recess to affect the active surface of the piezo element in a way that does not cause any interference modes. Moreover, this will eliminate the need to align the rotational orientation of the piezo actuator prior to the bonding procedure.

The piezo element or the piezo actuator may be disc-shaped. The piezo element or the piezo actuator is preferably in the shape of an annular disc, preferably having a circular contour. The piezo element or the piezo actuator can be rotationally symmetrical. The recess may be located in the region of the rotational axis or may be parallel to the rotational axis of the piezo actuator or the piezo element.

Preferably, the electrode is not a separate component, but rather a metallised surface formed on the piezo element or a metallised surface of the piezo element.

The electrode is preferably configured as a metallisation applied over a surface of the piezo element. Preferably, the electrode surface is flat, extending exclusively in one plane.

Preferably, the recess of the piezo element has a wall which is further preferably inclined with respect to the first side of the piezo element, in particular by approximately 90 degrees.

If the piezo element is arranged rotationally symmetrical about an axis of rotation and the electrode is point-symmetrical to the axis of rotation or rotationally symmetrical to this same axis of rotation, then provision is made for ensuring that twisting the piezo actuator during assembly has no negative effects. Therefore, there is no need for any alignment means, such as an alignment notch, to be present in the piezo actuator, and thus a larger active surface of the piezo actuator is possible.

If the piezo actuator is configured as an annular disc bonded within the sensor, in particular with centric recontacting, the piezo actuator can be particularly insensitive to tolerances during assembly. It has been shown that this applies not only to the rotational orientation of the piezo actuator, but, surprisingly, also to the position of the piezo actuator within the sensor.

In addition to the electrode surface, the electrode can also have a connecting portion. The connecting portion is preferably inclined with respect to the electrode surface. It may have the shape of a hollow cylinder merging into the electrode surface in the region of the edges of the recess. The electrode can thus have the shape of a circular surface including a hole and a hollow cylinder adjoining the edges of the hole. Preferably, the hole is congruent with the recess and further preferably it is arranged around the axis of rotation of the piezo element or the piezo drive. The connecting portion can extend into the recess of the piezo element. The connecting portion may comprise, or be formed by, a metallisation of the wall of the recess formed in the piezo element. Preferably, the electrode, or the metallisation of the piezo element forming the electrode, extends in particular seamlessly from the side of the piezo element facing the membrane to the wall of the recess.

If the electrical connection includes the connecting portion of the electrode, contacting the electrode surface may be achieved with particular ease.

The electrical connection may comprise establishing contact, in particular, between an electrical line and the electrode or the connecting portion. The contacting can comprise utilising an electrically conductive adhesive. Contact may be made by soldering.

The contactability of the electrode surface can be simplified, particularly in embodiments in which a positioning means is arranged in the recess of the piezo element, if the connecting portion has a region that extends on the side of the piezo element facing away from the membrane. In this embodiment, the electrode thus extends on both sides of the piezo element. Preferably, the size of the surface area of the connecting portion of the electrode extending on the side of the piezo element facing away from the membrane is less than 1/10 or 1/20 of the size of the electrode surface. The size of the electrode on the side of the piezo element facing away from the membrane is therefore preferably less than 1/10 or 1/20 of the size of the electrode on the side of the piezo element facing towards the membrane. It has been shown that this results in only a slight reduction in the active surface of the piezo element, which is beneficial to the performance of the piezo actuator and, on the other hand, is sufficient for reliably contacting the electrode.

The region of the connecting portion which extends on the side of the piezo element facing away from the membrane can be annular, in particular circularly annular. This region may be collar-shaped. This region can be arranged around the recess of the piezo element.

If the electrical connection includes an electrically conductive adhesive for contacting the electrode, the electrical connection will be easy to establish and will operate reliably. The electrically conductive adhesive can be arranged at least partially in the recess of the piezo element. The electrically conductive adhesive can make contact with the connecting portion of the electrode and, in particular, with the metallisation formed on the wall of the recess of the piezo element. The electrically conductive adhesive may alternatively or additionally make contact with the region of the connecting portion extending on the side of the piezo element facing away from the membrane. The electrically conductive adhesive, optionally together with a connecting portion of the electrode, can fill all or part of the recess.

Preferably, the electrically conductive adhesive interconnects constituent parts of the electrical connection, such as the connecting portion of the electrode and, for example, an electrical line, in particular a flex conductor, with each other, specifically through electrical and/or mechanical means.

The same adhesive material can be used for both the adhesive connection operatively connecting the piezo actuator to the membrane and for the electrically conductive adhesive of the electrical connection. It is conceivable that the filling of the recess and/or the contacting of the electrode can be achieved simultaneously with the creation of the adhesive connection in a single process step by using one and the same electrically conductive adhesive.

Preferably, the adhesive used for the adhesive connection and the electrically conductive adhesive are two different adhesives. Preferably, the adhesive connection comprises an adhesive optimised for maximal strength and minimal thickness. The electrically conductive adhesive of the electrical connection can be softer or more viscous than the adhesive used for the adhesive connection that operatively connects the piezo actuator to the membrane. It has been shown that the manufacturing of the sensor can be facilitated if the adhesive connection that operatively connects the piezo actuator to the membrane can be manufactured first, and the electrically conductive adhesive can be applied and/or contact with the electrode can be made at a later stage, once said adhesive connection has cured.

Preferably, a compensating element, e.g. a compensating ceramic element, is disposed between the membrane and the piezo actuator for adjustment purposes between the thermal expansion coefficients of the membrane and the piezo element. Such a compensating element, typically in the form of a disc, can absorb thermal expansions of the membrane and thus largely avoid electrical voltages that might otherwise be caused by thermal stresses. This type of compensating element can be used in particular to avoid or reduce mechanical stresses that can result in failure or breakage of the piezo actuator.

The effects caused by differences in thermal expansion between the piezo element and the membrane can thus be mitigated. Preferably, the compensating element is electrically non-conductive. The adhesive connection is preferably arranged between the piezo actuator and the compensating element. The compensating element is preferably bonded to the membrane.

Another electrode is preferably arranged on the side of the piezo element facing away from the membrane. Preferably, the sensor comprises another electrical connection, preferably arranged between the other electrode and the electronic system. Preferably, the electronic system can be used to realise or tap a difference in potential between the electrode and the other electrode. Preferably, the electronic system, the electrode and the other electrode can be used to apply or tap a difference in potential between the opposite sides or surfaces of the piezo element.

The surface area in which the electrode and the other electrode, spaced apart by the piezo element, overlap can be referred to as the active surface of the piezo element. Preferably, the active surface of the piezo element is greater than 7/10 or 8/10 or 9/10 of the base surface of the piezo element. Preferably, the active surface is rotationally symmetrical. The active surface may be equal to the surface of the other electrode. The preferred rotational symmetry of the active surface may ensure, or contribute to, the insensitivity of the piezo actuator to torsion.

The other electrode is preferably annular, in particular shaped in the form of a circular ring. The other electrode is preferably arranged around the recess. The other electrode can extend over at least almost the entire side of the piezo element facing away from the membrane, preferably with the exception of an inner circular ring arranged around the recess for the purpose of creating an insulating distance to insulate the other electrode from the electrode. Preferably, the other electrode is arranged so as to be rotationally symmetrical about the same axis of rotation as the electrode. Preferably, the piezo actuator has exactly two electrodes. For this reason, the sensor preferably only has two electrical connection zones or contacts for making contact with the electrodes of the piezo actuator. The connection zones may comprise a soldered, bonded and/or welded connection.

In an advantageous configuration, the sensor comprises positioning means for positioning the piezo actuator and/or the compensating element relative to the membrane. This can simplify the alignment of the piezo actuator with regard to its position before bonding, in particular before creating the adhesive connection. The positioning means can be used to co-operate with the recess formed in the piezo element. The positioning means can be configured to locate the piezo actuator also with respect to its rotational orientation. Preferably, however, the positioning means only specify the position, and not the rotational orientation, of the piezo actuator within the sensor or sensor housing. Since the piezo actuator is not sensitive to twisting, there is no need for specifying its rotational orientation.

The positioning means may comprise a die—in particular a cylindrical die—of the compensating element formed on the side of the compensating element facing towards the piezo actuator. The die can be disposed within the recess of the piezo element. The die may serve to centre the piezo actuator relative to the compensating element. The cylindrical die can have a diameter that corresponds to the diameter of the recess formed in the piezoelectric element. The height of the die can correspond to the height of the piezo element. In this embodiment, in particular, the connecting portion of the electrode preferably has a region which extends on the side of the piezo element facing away from the membrane and serves for making contact with the electrode surface formed on the side of the piezo element facing away from the membrane.

A particularly reliable positioning of the piezo actuator and the compensating element relative to the membrane can be achieved if the positioning means comprise two centring pins arranged on either side of the compensating element. These can engage with both the recess in the piezo element and a corresponding cavity formed in the membrane.

In one embodiment, the positioning means can comprise a membrane centring pin. The compensating element can comprise a cavity that can be in alignment with the recess of the piezo element and the centring pin can extend through the cavity and into the recess. This allows both the piezo actuator and the compensating element to be centred relative to the membrane. The centring pin can be integrally formed in one piece with the membrane, for example by a turning process performed on the membrane surface. Alternatively, the centring pin is not an integral part, but is designed as a component separate from the membrane. The centring pin can comprise an electrically non-conductive material and may be connected to the membrane, e.g. by bonding or press-fitting.

The positioning means may comprise a membrane depression that corresponds to the contour of the compensating element for receiving said compensating element.

In a further embodiment, the electrical connection can be configured as the inner conductor of a coaxial connection. For example, the electrical connection can be realised as the inner conductor of a coaxial cable, with said inner conductor protruding at least partially into the recess. The inner conductor of the coaxial cable may be stepped for a length that corresponds approximately to the thickness of the piezo element and may be inserted into the opening of the piezo element. There, the inner conductor can be connected to the electrode in an electrically conductive manner by means of an electrically conductive adhesive whilst at the same time being mechanically fixed. The bonding with the connecting portion and the establishing of electrical contact therewith can be made on the circumference of the inner conductor, but can also be made, at least partially, by means of a bonding realised on the end face.

The inner conductor preferably penetrates the recess by at least one half, more preferably by at least 80%, particularly preferably almost completely. The greater the overlap between the inner conductor and the recess, the larger the surface available for electrical and/or mechanical contacting. This makes it possible to achieve a particularly good and stable, electrical and/or mechanical connection.

Preferably, a diameter of the inner conductor is adapted to a diameter of the recess in such a way that a defined spacing will remain between the inner conductor and the inner wall of the recess, which is to be bridged by the electrically conductive adhesive. Precise adjustment can be achieved, for example, by using a calibration tool with which the diameter of the inner conductor is machined during or after placement so that it fits perfectly into the recess.

The other electrode can be contacted by an outer conductor of the coaxial connection. The outer conductor may equally be bonded to the other electrode in an electrically conductive manner, preferably on the end face.

In this way, an electrical and mechanical connection between the piezo element and the electrical supply line can be achieved particularly easily and without any additional components.

The membrane can be fitted with two oscillating forks, functioning as mechanical oscillators.

Further practical advantages and embodiment examples will be described below in conjunction with the figures. In the drawings:

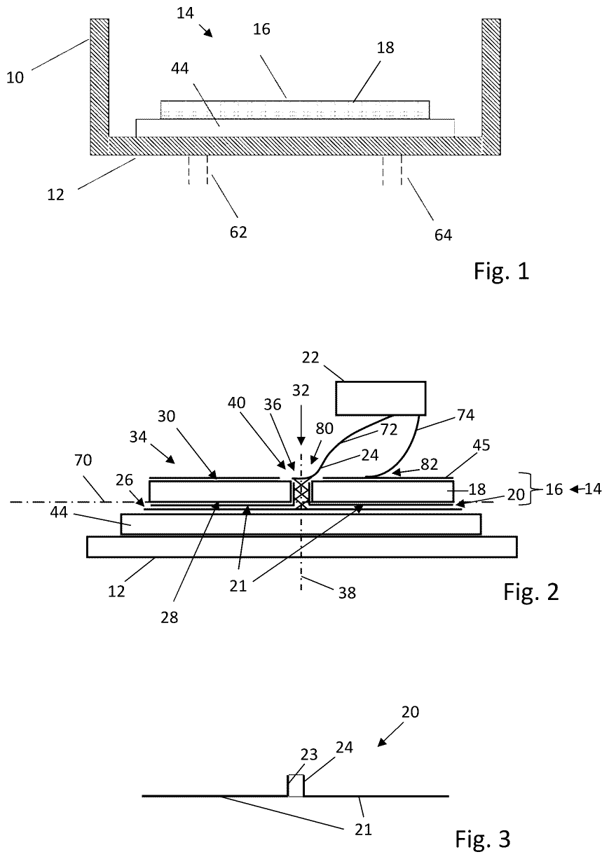

FIG. 1 schematically shows a cross-sectional representation of a part of a vibration sensor known from prior art,

FIG. 2 shows a cross-sectional representation of a part of a first embodiment example of a vibration sensor,

FIG. 3 shows the electrode of the vibration sensor shown in FIG. 2,

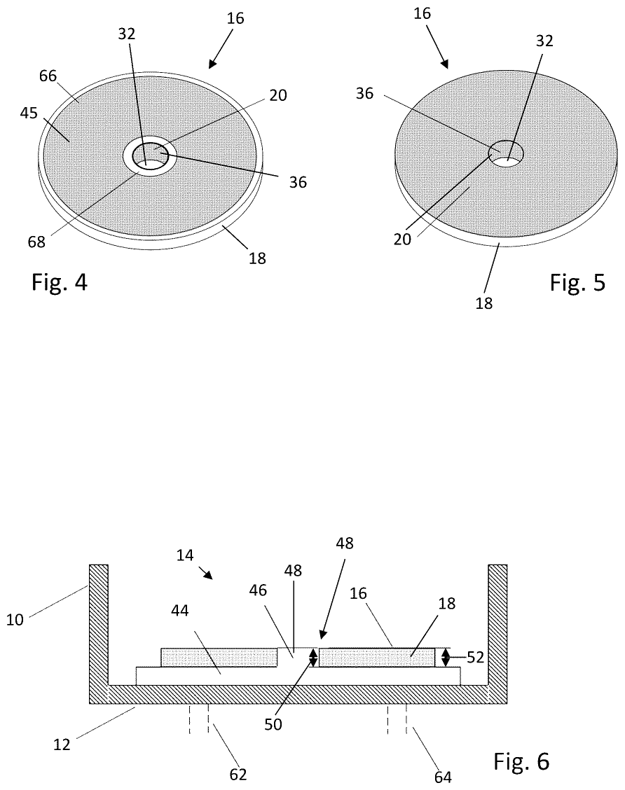

FIG. 4 shows a perspective representation of the piezo actuator of FIG. 2, viewed from the side facing away from the membrane,

FIG. 5 shows a representation as in FIG. 4, but with a view of the side facing towards the membrane,

FIG. 6 shows a cross-sectional representation of a part of a first embodiment example of a vibration sensor,

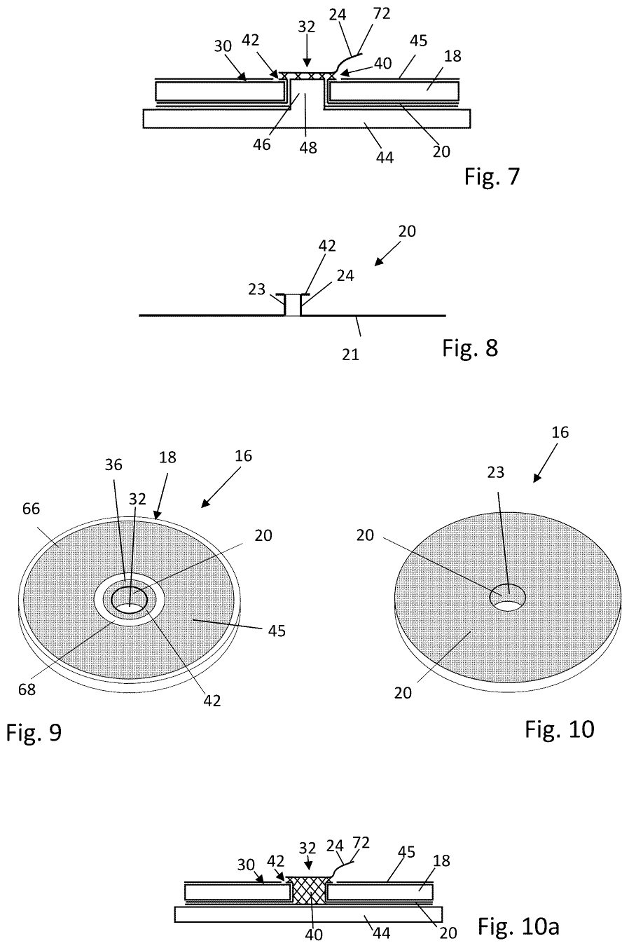

FIG. 7 shows a more detailed representation of a part of the vibration sensor of FIG. 6,

FIG. 8 shows the electrode of FIG. 7,

FIG. 9 shows a perspective representation of the piezo actuator of FIG. 7, viewed from the side facing away from the membrane,

FIG. 10 shows a perspective representation of the piezo actuator of FIG. 7, viewed from the side facing towards the membrane,

FIG. 10a shows a cross-sectional representation of a part of a further embodiment example of a vibration sensor,

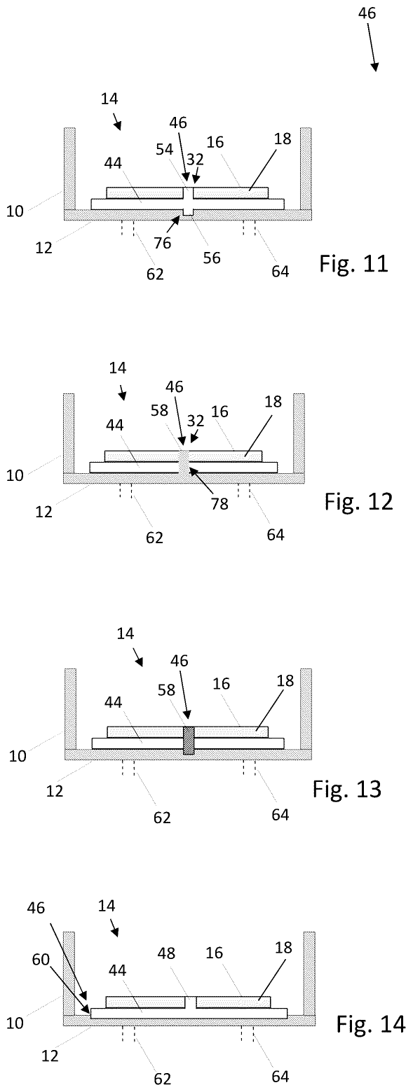

FIGS. 11 to 14 show cross-sectional representations of parts of further embodiment examples of a vibration sensor.

FIG. 1 shows a rough sketch of a part of a vibration sensor known from prior art.

A piezo actuator 16 including a piezo element 18 in the form of an annular disc is bonded to an insulating compensating element 44 made of ceramic material. The structure consisting of the piezo actuator 16 and the compensating element 44 is in turn fixed on a membrane 12 by means of an adhesive connection. The membrane 12 merges into a housing 10 or is attached thereto. In a structure of this type, the membrane 12 may be set in vibration by applying an electrical potential to the piezo element 18. On the outer side of the membrane 12 there may be further elements capable of mechanical oscillation, such as fork arms 62, 64 of an oscillating fork, which in FIG. 1 are merely sketched out by dashed lines. The side of the piezo actuator facing the membrane is not freely accessible and therefore cannot be contacted directly.

The vibration sensor partially shown in FIG. 2 is used to detect fill levels, limit levels, or to monitor process parameters, and comprises a membrane 12 that can be set in vibration. The membrane 12, the housing 10, and the fork arms 62, 64 can be configured as shown in FIG. 1. The vibration sensor comprises a drive unit 14 in the form of a piezo actuator 16. The piezo actuator has a piezo element 18 and an electrode 20 connected to the piezo element 18. The electrode has an electrode surface 21.

In addition, the vibration sensor comprises an adhesive connection 26 by means of which the piezo actuator 16 is operatively connected to the membrane 12 in such a way that vibrations of the piezo actuator 16 can be transmitted to the membrane 12 and vice versa. In addition, the vibration sensor comprises an electronic system 22 and an electrical connection 24 between the electronic system 22 and the electrode surface 21.

The piezo element 18 has a recess 32 and the electrical connection 24 extends through this recess 32.

The piezo element 18 has a first side 28 facing towards the membrane 12. The electrode surface 21 is arranged exclusively on this first side 28. The piezo element 18 has a second side 30 facing away from the membrane 12. The recess 32 extends through the centre of the piezo element 18, from the first side 28 to the second side 30.

The piezo actuator 16 is configured as a bonded annular disc 34 with centric recontacting 36. The piezo element 18 and the electrode 20 are each arranged to be rotationally symmetrical about an axis of rotation 38.

In addition to the flat electrode surface 21, the electrode 20 has a connecting portion 23 extending into the recess 32, and the electrical connection 24 comprises this connecting portion 23.

The electrical connection 24 further comprises an electrically conductive adhesive 40 arranged within the recess 32 and highlighted by cross-hatching. More specifically, the electrical connection 24 comprises contacting the electrical line 72 with the connecting portion 23 and this contacting comprises the electrically conductive adhesive 40.

In the embodiment example shown in FIG. 2, the electrically conductive adhesive 40 completely fills the recess 32 so as to electrically and mechanically interconnect the connecting portion 23 of the electrode 20 and the electrical line 72. For this purpose, the adhesive connection 26 may first be established and, once it has cured, the electrically conductive adhesive 40 may be applied and cured.

As also shown in FIG. 2, the sensor comprises a compensating element 44 in the form of a compensating ceramic element disposed between the membrane 12 and the piezo actuator 16, and the adhesive connection 26 is interposed between the piezo actuator 16 and said compensating element 44. The compensating element 44 is in turn bonded to the membrane 12, which is not explicitly represented in FIG. 2.

As shown in FIG. 2 and, for example, in FIG. 4, another electrode 45 is arranged on the side 30 of the piezo element 18 facing away from the membrane 12 and the sensor comprises another electrical connection 74 connecting said other electrode 45 to the electronic system 22. The other electrode 45 has the shape of a circular ring 66, is arranged around the recess 32, and extends at least almost over the entire surface on the side of the piezo element 18 facing away from the membrane 12, with the exception of an inner circular ring 68 arranged around the recess 32 for isolating said other electrode 45 from the electrode 20.

As also shown in FIG. 2, the piezo element 18 extends in a plane 70 and has a base surface lying in this plane 70. The active surface of the piezo element is greater than 7/10 or 8/10 or 9/10 of the base surface of the piezo element. It can also be seen that the sensor has only two electrical connection zones 80, 82 for making contact with the electrodes 20, 45 of the piezo actuator 16.

FIG. 3 illustrates the shape of the electrode 20 of the embodiment example shown in FIG. 2, including the flat, circularly annular electrode surface 21 and the connecting portion 23. As shown in FIGS. 2 and 3, the electrode 20 extends over surfaces that are inclined with respect to each other and, in the embodiment example shown in these figures, has the shape of a circular surface including a hole and a hollow cylinder adjacent to the edges of said hole.

FIGS. 4 and 5 illustrate the structure of the piezo actuator 16 including the circularly annular piezo element 18, the electrode 20 as described above, and another circularly annular electrode 45.

FIGS. 6 to 10 show a further embodiment example. As can best be seen from FIG. 7, in this embodiment example the recess 32 of the piezo element is not completely filled with electrically conductive adhesive, but a positioning means 46 is arranged in this recess. For contacting the electrode surface 21, the connecting portion 23 additionally comprises a region 42 that extends on the side 30 of the piezo element facing away from the membrane. As shown in FIGS. 8 and 9, this region 42 is shaped in the form of a circularly annular collar and is arranged around the recess 32 of the piezo element 18.

As again shown in FIG. 7, the electrical connection 24 comprises establishing contact between the electrical line 72 and this region 42 by means of the conductive adhesive 40.

FIGS. 9 and 10 illustrate the structure of the piezo drive 16 including the circularly annular piezo element 18, the electrode 20 as described above and including the connecting portion 23 comprising the region 42, and another circularly annular electrode 45.

FIG. 10a shows a variant in which the connecting portion 23 of the electrode, as in the embodiment example shown in FIGS. 6 to 10, additionally has a region 42 extending on the side 30 of the piezo element facing away from the membrane, but in which there is no positioning means 46. As in the embodiment example shown in FIG. 2, the electrically conductive adhesive 40 completely fills the recess 32 of the piezo element.

FIGS. 6 and 11 to 12 show various configurations of positioning means 46 for positioning the piezo actuator 16 and the compensating element 44 relative to the membrane 12.

FIG. 6 shows the positioning means 46 in the form of a cylindrical die 48 of the compensating element 44 located on the side of the compensating element 44 facing towards the piezo actuator 16 and arranged in the recess 32 of the piezo element. The height 50 of the die corresponds to the height 52 of the piezo element.

FIG. 11 shows the positioning means 46 in the form of two centring pins 54, 56 that are arranged on either side of compensating element 44 and engage with both the recess 32 formed in the piezo element and a corresponding cavity 76 formed in the membrane.

FIG. 12 shows the positioning means 46 in the form of a membrane centring pin which is integrally formed with the membrane and which engages with the recess 32 of the piezo element by passing through a cavity 78 of the compensating element.

FIG. 13 shows the positioning means 46 in the form of a membrane centring pin which comprises an electrically non-conductive material and is connected to the membrane 12 by bonding.

FIG. 14 shows the positioning means 46, in addition to the cylindrical die 48, in the form of a membrane depression 60 for accommodating the compensating element 44.

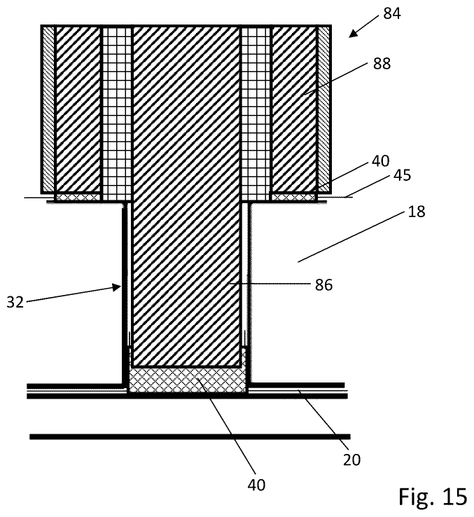

FIG. 15 is an enlarged detail representation of a further embodiment example of a vibration sensor including a piezo actuator 16 as shown in FIGS. 4 and 5, showing a sectional view in the longitudinal direction of the recess 32.

In this embodiment example, the piezo element 18 is electrically contacted on the one hand by an inner conductor 86 of a coaxial line 84, which is arranged within the recess 32 of the piezo element and is connected thereto both electrically and mechanically by means of the electrically conductive adhesive 40. The other electrode 45 is connected to the outer conductor 88 of the coaxial line 84, which is likewise mechanically and electro-conductively connected thereto by means of an electrically conductive adhesive 40.

Due to its merely central contacting, the piezo element 18 can be configured to be fully rotationally symmetrical, such that less stress will occur due to the deformation of the piezo, which, among other things, significantly increases the mechanical stress resistance and durability of the piezo element 18. Furthermore, since a contacting point located radially farther outwardly is no longer needed, this further reduces the structural stiffness, thus enabling a greater amplitude to be generated.

### REFERENCE SIGNS

10 housing
12 membrane
14 drive unit
16 piezo actuator
18 piezo element
20 electrode
21 electrode surface
22 electronic system
23 connecting portion of the electrode
24 electrical connection
26 adhesive connection
28 side of the piezo element facing towards the membrane
30 side of the piezo element facing away from the membrane
32 recess of the piezo element
34 bonded annular disc
36 centric recontacting
38 axis of rotation
40 electrically conductive adhesive
42 region of the connecting portion extending on the side of the piezo element facing away from the membrane
44 compensating element
45 other electrode
46 positioning means
48 cylindrical die of the compensating element
50 height of the cylindrical die
52 height of the piezo element
54 centring pin of the compensating element
56 centring pin of the compensating element
58 membrane centring pin
60 membrane depression
62 fork arm
64 fork arm
66 circular ring
68 inner circular ring
70 plane
72 electrical line
74 other electrical connection
76 cavity of the membrane
78 cavity of the compensating element
80 electrical connection zone
82 electrical connection zone
84 coaxial line
86 inner conductor
88 outer conductor

1. Vibration sensor for detecting fill levels, limit levels, or for monitoring process parameters, comprising:
a membrane that can be set in vibration,
a drive unit, wherein the drive unit comprises a piezo actuator which has a piezo element and an electrode with an electrode surface connected to the piezo element,
an adhesive connection, with the aid of which the piezo actuator is operatively connected to the membrane in such a way that vibrations of the piezo actuator can be transmitted to the membrane,
an electronic system,
an electrical connection between the electronic system and the electrode surface,
wherein the piezo element has a recess and the electrical connection extends through this recess.

2. The vibration sensor as claimed in claim 1, wherein
the piezo element has a first side facing towards the membrane and a second side facing away from the membrane and the electrode surface is arranged on said first side.

3. The vibration sensor as claimed in claim 1, wherein
the recess extends through the center of the piezo element.

4. The vibration sensor as claimed in claim 1, wherein
the piezo actuator is rotationally symmetrical.

5. The vibration sensor as claimed in claim 1, wherein
the piezo actuator is configured as an annular disc bonded within the sensor and includes a centric recontacting.

6. The vibration sensor as claimed in claim 1, wherein
the electrical connection comprises a connecting portion extending into the recess of the electrode.

7. The vibration sensor as claimed in claim 6, wherein
the connecting portion has a region that extends on the side of the piezo element facing away from the membrane.

8. The vibration sensor as claimed in claim 1, wherein
the electrical connection comprises an electrically conductive adhesive arranged within the recess.

9. The vibration sensor as claimed in claim 1, wherein
the sensor comprises a compensating element disposed between the membrane and the piezo actuator and in that the adhesive connection is interposed between the piezo actuator and said compensating element.

10. The vibration sensor as claimed in claim 1, wherein
another electrode is arranged on the side of the piezo element facing away from the membrane.

11. The vibration sensor as claimed in claim 1, wherein
the sensor comprises positioning means for positioning the piezo actuator and/or the compensating element relative to the membrane.

12. The vibration sensor as claimed in claim 11, wherein
the positioning means comprise a cylindrical die of the compensating element located on the side of said compensating element facing towards the piezo actuator.

13. The vibration sensor as claimed in claim 11, wherein
the positioning means comprise two centering pins arranged on either side of compensating element.

14. The vibration sensor as claimed in claim 11, wherein
the positioning means comprise a membrane centering pin.

15. The vibration sensor as claimed in claim 11, wherein
the positioning means comprise a membrane depression (60) for accommodating the compensating element.

16. The vibration sensor as claimed in claim 1, wherein
the electrical connection is an inner conductor (86) of a coaxial connection, preferably as an inner conductor (86) of a coaxial cable, with said inner conductor (86) protruding at least partially into the recess, preferably by at least one half, more preferably by at least 80%, particularly preferably penetrating it almost completely, and being electrically connected therein with the electrode surface.
